(19) United States
(12) Patent Application Publication
(10) Pub. No.: US 2026/0287114 A1
(43) Pub. Date: Sep. 24, 2026

(54) MULTI-USE SUPPORT STRAP

(71) Applicant: Nicholas Tirrell Golden, Jonesboro, GA (US)

(72) Inventor: Nicholas Tirrell Golden, Jonesboro, GA (US)

(21) Appl. No.: 19/574,904

(22) Filed: Mar. 23, 2026

Related U.S. Application Data
(60) Provisional application No. 63/775,820, filed on Mar. 21, 2025.

(51) Int. Cl. F16M 13/02; F16L 3/14; F24F 13/02; H02G 3/30

(52) U.S. Cl. CPC F16M 13/02; F16L 3/14; F24F 13/0254; H02G 3/30

(57) ABSTRACT

A multi-use support strap and method of use are disclosed. The support strap may be an elongated flexible member, preferably fabricated from PVC, having a plurality of fastener holes formed proximate to each end. The strap spans between two adjacent structural members such as floor joists or ceiling joists and is mechanically secured thereto by fasteners driven through the fastener holes and into the structural members. The strap provides a secure support for a wide range of building system elements including batting insulation, plumbing pipes, HVAC conduit, and electrical wiring, preventing such elements from falling or shifting out of position over time. The multi-use design eliminates the need for separate single-purpose support products, reducing material cost and simplifying installation. The strap may also be used as a tie-down in non-construction applications.

### CROSS REFERENCE TO RELATED APPLICATION

This application claims the benefit of priority of U.S. provisional application No. 63/775,820, filed Mar. 21, 2025, the contents of which are herein incorporated by reference.

### BACKGROUND OF THE SUBJECT DISCLOSURE

The subject disclosure relates generally to building and construction hardware, and more particularly to a multi-use support strap for securing and retaining insulation, HVAC components, plumbing pipes, and electrical wiring between structural joists and beams in residential and commercial construction.

In residential and commercial construction, building systems such as plumbing pipes, HVAC ductwork and conduits, electrical wiring, and batting insulation are commonly installed in the spaces between floor joists, ceiling joists, and wall studs. Maintaining these elements in their installed positions over time is a persistent challenge. Insulation installed between floor joists, for example, is subject to gravity, vibration, settling of the structure, and changes in humidity, all of which can cause the insulation to sag or fall away from its intended position. Similarly, plumbing pipes, electrical cables, and HVAC components may shift or sag over time in the absence of proper support.

Existing products used to support these building system elements suffer from significant drawbacks. Many such products are designed for a single, specific purpose; for example, insulation support wires are configured only to hold insulation batting and cannot be adapted for use with pipes or electrical wires. Because a contractor or homeowner must purchase separate products for each application, the overall cost is high. Moreover, many existing support devices, such as insulation support wires pushed between joists rely only on friction and spring tension for retention and tend to fall out of place over time as the structure moves and the joists shift.

As can be seen, there is a need for a single, versatile, low-cost support strap that can be securely fastened to structural joists and used across a wide variety of applications including, but not limited to, supporting insulation, plumbing pipes, HVAC components, and electrical wiring.

### SUMMARY OF THE SUBJECT DISCLOSURE

The subject disclosure provides a multi-use support strap and method of installation that addresses the deficiencies of the prior art. In one embodiment, the subject disclosure comprises an elongated flexible strap member having a plurality of fastener holes formed along its length, allowing the strap to be mechanically fastened to structural joists or beams using standard drywall fasteners or similar fasteners. The strap may be fabricated from durable Polyvinyl Chloride (PVC) material and may be sized to span the space between adjacent joists, providing a secure cradle or support surface for insulation batting, pipes, HVAC components, electrical wiring, or other building system elements placed thereunder or therein.

Unlike prior art devices that rely on friction alone, the subject disclosure may be mechanically secured to the joists via fasteners on each side of the strap, preventing displacement due to structural movement, vibration, or the weight of supported materials. Because the strap may be designed to accommodate a wide range of applications, a single product eliminates the need to purchase multiple specialized support devices, reducing cost and simplifying the installation process.

In one embodiment, the support strap measures approximately twenty-eight inches (approximately 711.2 mm) in length and approximately 3/4-inch (approximately 19 mm) in width and may be used in combination with #6×1¼-inch drywall screws. These fasteners 14 are driven through fastener holes located near each end of the strap and into the adjacent structural joists, thereby securing the strap across the joist bay. The thickness of the strap is less than two millimeters and in some embodiments less than one millimeter, which critically lends itself to its advantages of being non-bulky, having a tremendously relative low weight comparted to the prior art, as well as being able, in some embodiments, to be slid between or around obstacles of supporting member due to this critical thickness. The PVC material still enable the strength of the support strap even at thicknesses less than one millimeter.

It is accordingly an object of the subject disclosure to provide a multi-use support strap that can be used to support insulation, pipes, HVAC components, and electrical wiring.

It is a further object of the subject disclosure to provide a support strap that is mechanically fastened to structural members to prevent displacement over time.

It is a still further object of the subject disclosure to provide a single, low-cost support device that replaces multiple single-purpose products.

These and other features, aspects and advantages of the present subject disclosure will become better understood with reference to the following drawings, description and claims.

### BRIEF DESCRIPTION OF THE DRAWINGS

FIG. 1 is a perspective view of the multi-use support strap of the subject disclosure.

FIG. 2 is a detailed perspective view of the multi-use support strap, showing the fastener holes formed in the strap.

FIG. 3 is an in-use view of the subject disclosure demonstrating installation between structural beams, with the strap supporting batting insulation.

FIG. 4 is an alternate in-use view of the subject disclosure, demonstrating installation with the strap supporting a pipe between structural joists.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides a multi-use support strap and method of use are disclosed. The support strap may be an elongated flexible member, preferably fabricated from PVC, having a plurality of fastener holes formed proximate to each end. The strap spans between two adjacent structural members such as floor joists or ceiling joists and may be mechanically secured thereto by fasteners driven through the fastener holes and into the structural members. The strap provides a secure support for a wide range of building system elements including batting insulation, plumbing pipes, HVAC conduit, and electrical wiring, preventing such elements from falling or shifting out of position over time. The multi-use design eliminates the need for separate single-purpose support products, reducing material cost and simplifying installation. The strap may also be used as a tie-down in non-construction applications.

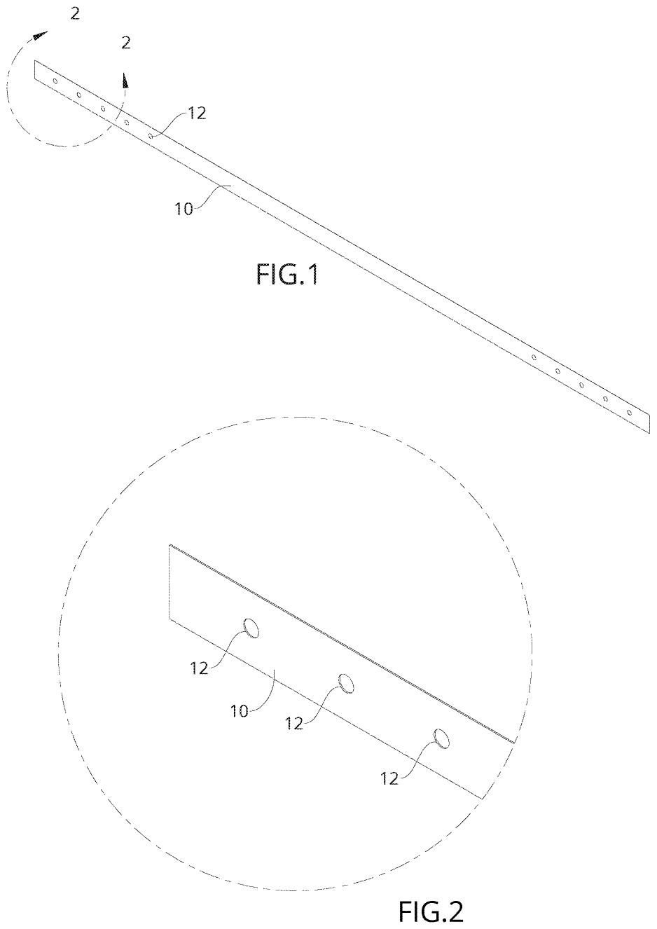

Referring now to FIGS. 1 and 2, the multi-use support strap 10 of the subject disclosure is shown. The strap 10 may be an elongated, generally flat member fabricated from a flexible PVC material. In a preferred embodiment, the strap 10 measures approximately 28 inches (approximately 711.2 mm) in length and approximately ¾-inch (approximately 19 mm) in width, though the dimensions may be varied to suit different applications and joist spacings without departing from the scope of the subject disclosure. The strap 10 may be manufactured by an extrusion process as is well known in the art.

Formed along the length of the strap 10 are a plurality of fastener holes 12. In the preferred embodiment, fastener holes 12 are positioned near each end of the strap 10 such that, upon installation, one fastener hole 12 may be aligned over each of the two adjacent structural members (e.g., joists or beams) between which the strap 10 may be secured. Fastener holes 12 are sized to accommodate standard drywall fasteners 14, which in the preferred embodiment may be #6×1¼-inch drywall fasteners made of galvanized metal. The provision of multiple fastener holes 12 along the strap 10 provides flexibility in positioning the strap 10 relative to the structural members and allows the same strap 10 to accommodate varying joist spacings. In one embodiment the fastener holes 12 have a diameter of approximately four millimeters and are spaced apart by approximately 25 millimeters.

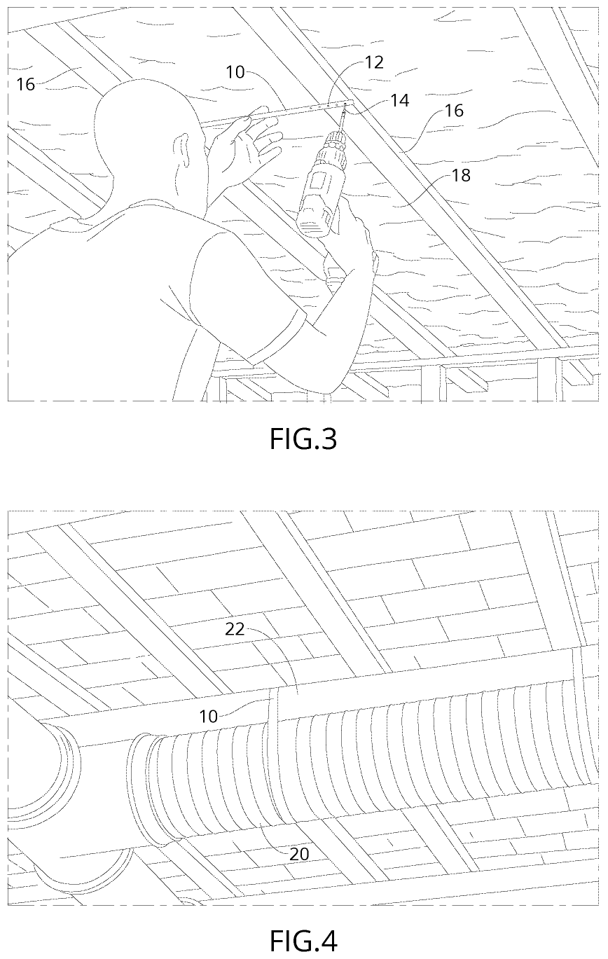

Referring now to FIG. 3, the strap 10 is shown installed between a pair of structural beams 16 to support a layer of batting insulation 18. To install the strap 10, the installer positions the strap 10 across the underside of two adjacent beams 16, aligning a fastener hole 12 over each beam 16. A fastener 14 may be then driven through each fastener hole 12 and into the respective beam 16, thereby mechanically securing the strap 10 in position. The batting insulation 18 may be then placed above and resting on strap 10, or the strap 10 may be installed beneath previously placed insulation to retain it in position. The strap 10 acts as a mechanical barrier preventing the batting insulation 18 from sagging or falling away from its installed position over time.

Referring now to FIG. 4, the strap 10 is shown in an alternate in-use configuration supporting a pipe 20 between structural joists 22. In this embodiment, the strap 10 may be installed as described above, with the fasteners 14 securing the strap 10 to the undersides of the adjacent joists 22. The pipe 20, which may be a plumbing pipe, HVAC ductwork/conduits, or similar elongated member, may be cradled within the loop formed by the strap 10 and the undersides of the joists 22. The strap 10 prevents pipe 20 from dropping or shifting from its installed position. It will be understood by people skilled in the art that electrical wires, cables, HVAC components, and other building system elements may be similarly supported by the strap 10 of the subject disclosure.

Because the strap 10 may be mechanically fastened to the structural members 16, 22 by fasteners 14, rather than relying solely on friction or spring tension as in prior art devices, the strap 10 remains securely in place even as the structure settles, vibrates, or otherwise moves over time. This represents a significant improvement over prior art insulation support wires and other single-purpose retaining devices.

The multi-use nature of the strap 10 is a further advantage. The same strap 10 may be used in any application requiring the support or retention of building system elements between structural members. This eliminates the need for contractors and homeowners to purchase and maintain multiple single-purpose support products, reducing costs and simplifying inventory.

Additionally, straps 10 may be used in a wide range of applications beyond building construction, including, without limitation, tie-downs for securing objects in vehicles, trailers, storage areas, and similar environments.

It will be apparent to those skilled in the art that various modifications and variations can be made in the multi-use support strap of the subject disclosure and in construction of this subject disclosure without departing from the scope or spirit of the subject disclosure. The material of the strap may be varied (e.g., metal, nylon, or composite materials); the dimensions may be varied to suit different joist spacings; and the number, size, and placement of the fastener holes may be modified. Other embodiments of the subject disclosure will be apparent to those skilled in the art from consideration of the specification and practice of the subject disclosure disclosed herein. It is intended that the specifications and examples be considered as exemplary only, with a true scope and spirit of the subject disclosure being indicated by the following claims

As used in this application, the term “about” or “approximately” refers to a range of values within plus or minus 10% of the specified number. And the term “substantially” refers to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A multi-use support strap comprising:
an elongated strap member formed from a flexible material and having a first end and a second end;
a plurality of fastener holes formed through the strap member proximate to the first end and the second end thereof; and
wherein the strap member is configured to span between two adjacent structural members such that at least one fastener hole at the first end is alignable over a first structural member and at least one fastener hole at the second end is alignable over a second structural member, permitting mechanical fasteners to be driven through the fastener holes and into the respective structural members to secure the strap member therebetween.

2. The multi-use support strap of claim 1, wherein the flexible material is Polyvinyl Chloride (PVC).

3. The multi-use support strap of claim 1, wherein the strap member has a width of approximately 19 millimeters (mm) and a thickness of less than two mm.

4. The multi-use support strap of claim 1, wherein the mechanical fasteners are drywall screws.

5. The multi-use support strap of claim 4, wherein the drywall screws are #6×1¼ inch galvanized drywall screws.

6. The multi-use support strap of claim 1, wherein the structural members are floor joists or ceiling joists.

7. The multi-use support strap of claim 1, wherein the strap member is configured to support at least one of batting insulation, a plumbing pipe, HVAC conduit, and electrical wiring between the two adjacent structural members.

8. The multi-use support strap of claim 1, wherein the plurality of fastener holes is spaced along the length of the strap member to accommodate varying spacing between the adjacent structural members.

9. A method of supporting building system elements between adjacent structural members, comprising:
positioning an elongated support strap across the undersides of two adjacent structural members, the support strap having a plurality of fastener holes formed proximate to each end thereof;
driving a first fastener through a fastener hole proximate to a first end of the support strap and into a first structural member;
driving a second fastener through a fastener hole proximate to a second end of the support strap and into a second structural member, thereby mechanically securing the support strap between the first and second structural members; and
supporting at least one building system element against the support strap between the two adjacent structural members,
wherein the elongated support strap across is formed from Polyvinyl Chloride (PVC), and
wherein the strap member has a width of approximately 19 millimeters (mm) and a thickness of less than two mm.

10. The method of claim 9, wherein the building system element is batting insulation.

11. The method of claim 9, wherein the building system element is a plumbing pipe.

12. The method of claim 9, wherein the building system element is at least one of an HVAC component, electrical wiring, and a cable.

13. The method of claim 9, wherein the fasteners are #6×1¼ inch drywall screws.
